(19) United States
(12) Patent Application Publication
(10) Pub. No.: US 2026/0038792 A1
(43) Pub. Date: Feb. 5, 2026

(54) SOLVENT-FREE ELECTRODE

(71) Applicant: FORD GLOBAL TECHNOLOGIES, LLC, Dearborn, MI (US)

(72) Inventors: Insik JEON, Novi, MI (US); Jonghwan PARK, Ann Arbor, MI (US); Wei XU, Livonia, MI (US); DongHyun LEE, Northville, MI (US)

(21) Appl. No.: 18/794,554

(22) Filed: Aug. 5, 2024

(51) Int. Cl. H01M 4/04; H01M 4/60; H01M 10/0525

(52) U.S. Cl. CPC H01M 4/0404; H01M 4/0416; H01M 4/604; H01M 10/0525

(57) ABSTRACT

A lithium-ion battery component and methods for producing the lithium-ion battery component are presented. The lithium-ion battery component includes a current collector and a solvent-free electrode layer laminated onto the current collector. The solvent-free electrode layer has an active material, a conductive additive, a binder, and a fluorinated polyether in a dry mixture. The fluorinated polyether is incorporated to promote interfacial contact and adhesion between the solvent-free electrode layer and the current collector.

### TECHNICAL FIELD

This disclosure relates to solvent-free electrodes for battery cells.

### BACKGROUND

Conventional methods for manufacturing electrodes involve applying a mixture of active materials, conductive additives, and binders onto a metal current collector foil using a solvent-based coating process. The coated electrode is then dried to remove the solvent, leaving a solid electrode film adhered to the current collector. While widely used, this solvent-based electrode coating process may have several drawbacks.

### SUMMARY

In one aspect of the disclosure, a lithium-ion battery component is presented. The lithium-ion battery component includes a current collector and a solvent-free electrode layer laminated onto the current collector. The solvent-free electrode layer has an active material, a conductive additive, a binder, and a fluorinated polyether in a dry mixture to promote interfacial contact and adhesion between the solvent-free electrode layer and the current collector. The fluorinated polyether may be a hydrofluoroether. The hydrofluoroether may be selected from a group including methoxy-nonafluorobutane, ethoxy-nonafluorobutane, 3-methoxyperfluoro(2-methylpentane), and 2-trifluoromethyl-3-ethoxydodecofluorohexane. The fluorinated polyether may have a boiling point of 200° C. or less. In other configurations, the fluorinated polyether has a boiling point of 150° C. or less. The fluorinated polyether may have a surface tension of 25 mN/m or less. In other configurations, the fluorinated polyether has a surface tension of 20 mN/m or less. In further configurations, the fluorinated polyether has a surface tension of 15 mN/m or less. The fluorinated polyether may be 0.1 to 20 wt. % of the solvent-free electrode layer.

In another aspect of the disclosure, a method of manufacturing an electrode is presented. The method includes dry-mixing an active material, a conductive additive, a binder, and a fluoro-based lubricant to form a dry electrode mixture, dry coating the dry electrode mixture onto a current collector, and laminating the dry electrode mixture onto the current collector. The fluoro-based lubricant may be a hydrofluoroether. The hydrofluoroether may be selected from a group including methoxy-nonafluorobutane, ethoxy-nonafluorobutane, 3-methoxyperfluoro(2-methylpentane), and 2-trifluoromethyl-3-ethoxydodecofluorohexane. The fluoro-based lubricant may have a boiling point of 200° C. or less. In other configurations, the fluoro-based lubricant has a boiling point of 150° C. or less. The fluoro-based lubricant may have a surface tension of 25 mN/m or less. The fluoro-based lubricant may be 0.1 to 20 wt. % of the dry electrode mixture.

In another aspect of the disclosure, another lithium-ion battery component is presented. The lithium-ion battery component includes a current collector and a solvent-free electrode laminated onto the current collector. The solvent-free electrode has an active material, a conductive additive, a binder, and a hydrofluoroether that reduces inter-particle friction of the active material, conductive binder and hydrofluoroether, and increases interfacial contact between the solvent-free electrode and current collector. The hydrofluoroether may be selected from a group including methoxy-nonafluorobutane, ethoxy-nonafluorobutane, 3-methoxyperfluoro(2-methylpentane), and 2-trifluoromethyl-3-ethoxydodecofluorohexane. The hydroluorofluoroether additive has a boiling point of 200° C. or less and a surface tension of 25 mN/m or less. The hydrofluoroether additive may be 0.1 to 20 wt. % of the solvent-free electrode.

### BRIEF DESCRIPTION OF THE DRAWINGS

FIG. 1 is a schematic diagram of additives according to one or more aspects of the disclosure;

FIG. 2 is a schematic diagram of an electrode according to one or more aspects of the disclosure;

FIG. 3 is a schematic diagram of a manufacturing process according to one or more aspects of the disclosure;

FIG. 4 is a schematic diagram of a manufacturing process according to one or more aspects of the disclosure; and

FIG. 5 is a flowchart of a manufacturing method according to one more aspects of the disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Unless otherwise explicitly specified, all numerical values and ranges relating to quantities, measurements, percentages, weights, and similar numerical references within this document are to be understood as being preceded by the term “about.” This applies even in cases where the term “about” is not explicitly used. It is intended that all values and ranges encompass variations that may arise from standard measurement, manufacturing processes, material properties, and intended functionality of aspects of the disclosure. For example, a stated dimension of “10 mm” should be interpreted as “about 10 mm.” Similarly, when a composition is described as having “5 wt. % of a component,” it is to be understood as “about 5 wt. % of a component.” Furthermore, when numerical values are presented as a range, such as “100 to 200 units,” this range should be interpreted to effectively mean “about 100 to about 200 units.” Such variations are implicitly incorporated within the scope of the present disclosure.

The present disclosure relates to methods for manufacturing high performance lithium-ion battery electrodes using a hybrid solvent-based and solvent-free coating process. Current methods for manufacturing electrodes involve applying a mixture of active materials, conductive additives, and binders onto a metal current collector foil using a solvent-based coating process. The coated electrode is then dried to remove the solvent, leaving a solid electrode film adhered to the current collector. This solvent-based electrode coating process may involve the use of volatile solvents, have long drying times, and result in a need for solvent recovery and disposal methods.

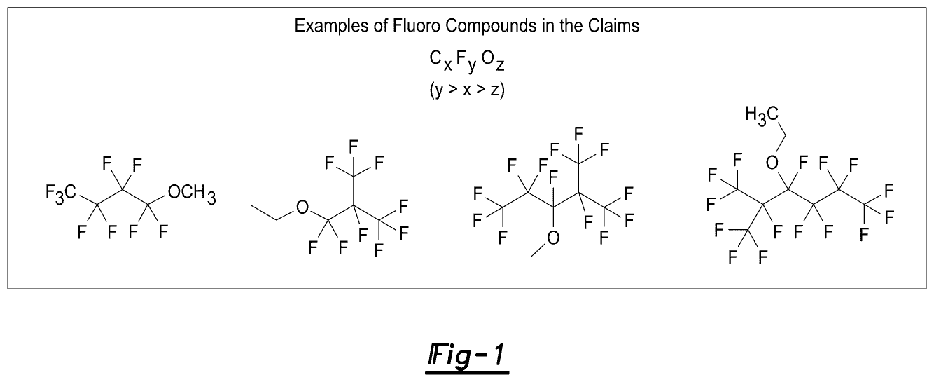

FIG. 1 is a schematic diagram of additives according to one or more aspects of the disclosure. The figure illustrates examples of fluoro compounds utilized as additives in the electrode manufacturing process, specifically hydrofluoroethers. These additives play a role in reducing friction during the dry mixing of electrode components and preventing contamination on pressing compression tools during lamination onto the current collector. A general molecular formula CₓF_{y}O_{z} is shown, where x, y, and z represent the number of carbon, fluorine, and oxygen atoms, respectively. The relationship between these variables is y>x>z, this implies that these compounds contain more fluorine atoms than carbon atoms, and more carbon atoms than oxygen atoms. This composition contributes to the properties of these additives, particularly their low surface tension and ability to reduce inter-particle friction. Four specific examples of hydrofluoroethers are provided, each with a distinct molecular structure. These structures range from simpler compounds with a perfluorinated butyl group attached to either a methoxy or ethoxy group, to more complex molecules featuring larger perfluorinated alkyl chains with branching. The largest molecule shown includes a perfluorinated heptyl group with a trifluoromethyl branch. All of these compounds share the characteristic of having fully fluorinated alkyl portions connected to alkoxy groups, which gives them their desirable properties for use in solvent-free electrode manufacturing.

These hydrofluoroethers typically have low boiling points, generally at or below 200° C. and preferably at or below 150° C., which allows them to evaporate easily during the manufacturing process. Their surface tension is remarkably low, usually at or below 25 mN/m, with preferred values at or below 20 mN/m, and ideal values at or below 15 mN/m. This low surface tension enables better wetting and dispersion of the electrode components. The fluorinated structure of these additives effectively reduces inter-particle friction during the dry mixing of active materials, conductive agents, and binders, helping to prevent mechanical degradation to the active materials during processing. Additionally, these compounds aid in preventing contamination on pressing compression tools during the lamination of the electrode mixture onto the current collector. The molecular structures shown in FIG. 1 present a range of hydrofluoroethers that may be utilized in the disclosed manufacturing process, and blended with the electrode materials in proportions ranging from 0.1 to 20 wt. %. This allows for optimization of the manufacturing process while maintaining the desired electrode properties.

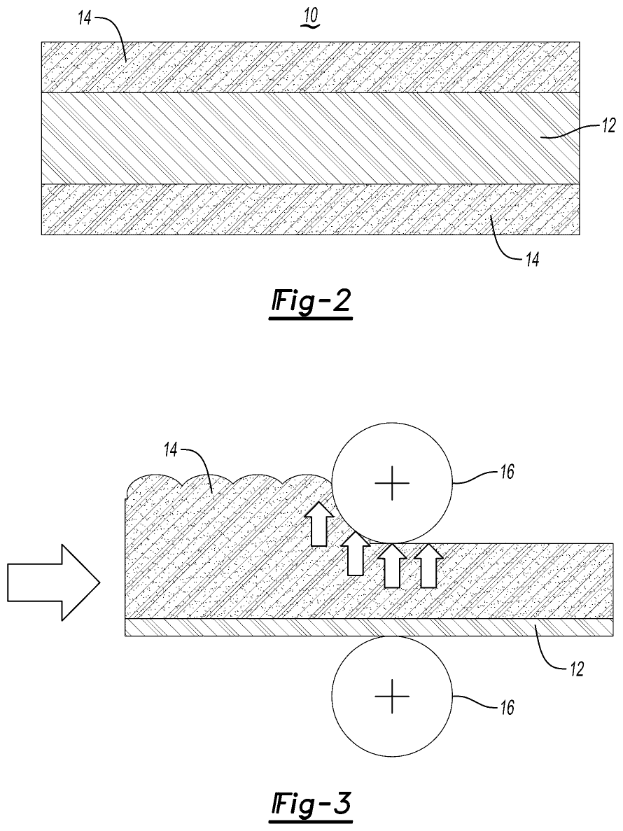

FIG. 2 is a schematic diagram of an electrode 10 according to one or more aspects of the disclosure. The electrode 10 includes a current collector 12 and an active material layer 14 which is solvent-free. The current collector 12 is a thin, central layer, which may be a conductive metal foil. Materials for the current collector may include copper for anodes, due to its stability at low potentials, and aluminum for cathodes, chosen for its light weight and corrosion resistance at high potentials. Other potential materials for current collectors may include nickel, titanium, or stainless steel, depending on the specific battery chemistry and performance requirements. The active material layer 14 is laminated onto the current collector 12. The active material layer 14 is shown on both the upper and lower surfaces of the current collector 12, however the electrode 10 may be configured with the active material layer 14 on one side or both sides of the current collector 12. This dual-sided configuration increases the active surface area and energy density of the electrode 10.

The active material layer 14 is a dry mixture containing active materials, conductive additives, binders, and the fluorinated polyether additives. For example, in a lithium-ion battery, the active material for a cathode may include lithium cobalt oxide, lithium nickel manganese cobalt oxide, or lithium iron phosphate. Anode active materials may include graphite, silicon, or lithium titanate. Conductive additives often used are carbon black or carbon nanotubes, while common binders include polyvinylidene fluoride or carboxymethyl cellulose. The interface between the active material layer 14 and the current collector 12 contributes to the performance of the electrode 10. The fluorinated polyether additives in the active material layer 14 contribute to promoting interfacial contact and adhesion between the active material layer 14 and the current collector 12. This adhesion helps maintain the structural integrity of the electrode 10 during battery cycling and facilitates efficient electron transfer between the active materials and the current collector 12.

The active material layer 14 may be thicker than the current collector 12 to maximize the amount of energy-storing active material while minimizing the non-active components. The current collector thicknesses may range from 6 to 25 micrometers, while the active material layer thickness may range from 50 to several hundred micrometers, depending on the specific battery design and application. The active material layer 14 may have a porous structure that allows for electrolyte penetration and ion transport during battery operation. The solvent-free manufacturing process, aided by the fluorinated polyether additives, contributes to achieving a uniform distribution of components and optimal porosity within the active material layer 14. The electrolyte, which may permeate this porous structure in an assembled battery, may include a lithium salt dissolved in organic solvents. Common lithium salts include lithium hexafluorophosphate or lithium bis(trifluoromethanesulfonyl)imide. Organic solvents used may be ethylene carbonate, dimethyl carbonate, or diethyl carbonate, solely or in combination.

FIGS. 3 and 4 are schematic diagrams of a solvent-free electrode manufacturing process. A compression tool 16 is used for lamination of the active material layer 14 to the current collector 12. In FIG. 3, the active material layer 14 is pressed onto the current collector 12 by the upper compression tool 16. The lower compression tool 16 provides counter-pressure for even force distribution. FIG. 4 shows a simultaneous application of the active material layer 14 to both sides of the vertically oriented current collector 12. The compression tools 16 on either side apply pressure to laminate the layers 14. This compression tool-based dry process allows for uniform pressure to achieve adequate adhesion and precise thickness control, and promotes better interfacial contact aided by the fluorinated polyether additives.

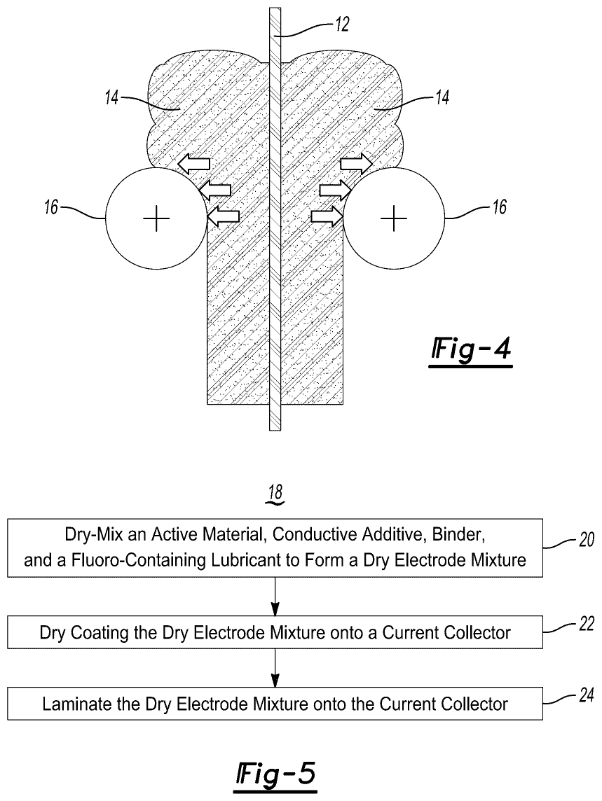

FIG. 5 is a flowchart of steps in a manufacturing process 18 of a solvent-free electrode for a lithium-ion battery. Step 20 includes dry-mixing an active material, conductive additive, binder, and a fluoro-containing lubricant to form a dry electrode mixture. Step 20 combines all necessary components without using solvents, with the fluoro-containing lubricant playing a role in reducing inter-particle friction. Step 22 includes the dry coating of the dry electrode mixture onto a current collector. Step 24 includes laminating the dry electrode mixture onto the current collector, the application of pressure in step 24 is high enough to ensure good adhesion and electrical contact.

While exemplary embodiments are described above, it is not intended that these embodiments describe all possible forms of the invention. Rather, the words used in the specification are words of description rather than limitation, and it is understood that various changes may be made without departing from the spirit and scope of the invention.

As previously described, features of various embodiments can be combined to create further embodiments of the invention that may not be explicitly described or illustrated. Although certain embodiments may be described as offering advantages or being preferred over other embodiments or prior art implementations with respect to specific characteristics, those skilled in the art will recognize that certain features or characteristics may be adjusted to achieve the desired overall system attributes, depending on the specific application and implementation. These attributes can include, but are not limited to, strength, durability, marketability, appearance, packaging, size, serviceability, weight, manufacturability, and ease of assembly. Consequently, embodiments that may be considered less desirable in terms of one or more characteristics are not outside the scope of the disclosure and may be suitable for particular applications.

What is claimed is:

1. A lithium-ion battery component comprising:
a current collector; and
a solvent-free electrode layer laminated onto the current collector, the solvent-free electrode layer being a dry mixture of an active material, a conductive additive, a binder, and a fluorinated polyether that is configured to promote interfacial contact and adhesion between the solvent-free electrode layer and the current collector.

2. The lithium-ion battery component of claim 1 wherein the fluorinated polyether is a hydrofluoroether.

3. The lithium-ion battery component of claim 2 wherein the hydrofluoroether is selected from a group including methoxy-nonafluorobutane, ethoxy-nonafluorobutane, 3-methoxyperfluoro(2-methylpentane), and 2-trifluoromethyl-3-ethoxydodecofluorohexane.

4. The lithium-ion battery component of claim 1 wherein the fluorinated polyether has a boiling point of 200° C. or less.

5. The lithium-ion battery component of claim 4 wherein the fluorinated polyether has a boiling point of 150° C. or less.

6. The lithium-ion battery component of claim 1 wherein the fluorinated polyether has a surface tension of 25 mN/m or less.

7. The lithium-ion battery component of claim 6 wherein the fluorinated polyether has a surface tension of 20 mN/m or less.

8. The lithium-ion battery component of claim 7 wherein the fluorinated polyether has a surface tension of 15 mN/m or less.

9. The lithium-ion battery component of claim 1 wherein the fluorinated polyether is 0.1 to 20 wt. % of the solvent-free electrode layer.

10. A method of manufacturing an electrode comprising:
dry-mixing an active material, a conductive additive, a binder, and a fluoro-based lubricant to form a dry electrode mixture;
dry coating the dry electrode mixture onto a current collector; and
laminating the dry electrode mixture onto the current collector.

11. The method of claim 10 wherein the fluoro-based lubricant is a hydrofluoroether.

12. The method of claim 11 wherein the hydrofluoroether is selected from a group including methoxy-nonafluorobutane, ethoxy-nonafluorobutane, 3-methoxyperfluoro(2-methylpentane), and 2-trifluoromethyl-3-ethoxydodecofluorohexane.

13. The method of claim 10 wherein the fluoro-based lubricant has a boiling point of 200° C. or less.

14. The method of claim 13 wherein the fluoro-based lubricant has a boiling point of 150° C. or less.

15. The method of claim 10 wherein the fluoro-based lubricant has a surface tension of 25 mN/m or less.

16. The method of claim 10 wherein the fluoro-based lubricant is 0.1 to 20 wt. % of the dry electrode mixture.

17. A lithium-ion battery comprising:
a current collector; and
a solvent-free electrode laminated onto the current collector, the solvent-free electrode having an active material, a conductive additive, a binder, and a hydrofluoroether additive that is configured to reduce inter-particle friction within the solvent-free electrode.

18. The lithium-ion battery of claim 17 wherein the hydrofluoroether additive is selected from a group including methoxy-nonafluorobutane, ethoxy-nonafluorobutane, 3-methoxyperfluoro(2-methylpentane), and 2-trifluoromethyl-3-ethoxydodecofluorohexane.

19. The lithium-ion battery of claim 17 wherein the hydroluorofluoroether additive has a boiling point of 200° C. or less and a surface tension of 25 mN/m or less.

20. The lithium-ion battery of claim 17 wherein the hydrofluoroether additive is 0.1 to 20 wt. % of the solvent-free electrode.
